(19) United States
(12) Patent Application Publication
(10) Pub. No.: US 2020/0180909 A1
(43) Pub. Date: Jun. 11, 2020

(54) BRAKE FOR AN ELEVATOR SYSTEM

(71) Applicants: thyssenkrupp Elevator AG, Essen (DE); thyssenkrupp AG, Essen (DE)

(72) Inventor: Christian SCHULZ, Stuttgart (DE)

(73) Assignees: thyssenkrupp Elevator AG, Essen (DE); thyssenkrupp AG, Essen (DE)

(21) Appl. No.: 16/619,561

(22) PCT Filed: Jun. 11, 2018
(86) PCT No.: PCT/EP2018/065330

§ 371 Date: Dec. 5, 2019

(30) Foreign Application Priority Data
Jun. 12, 2017 (DE) 10 2017 209 888.0

(51) Int. Cl. B66B 5/18; B66B 1/36

(52) U.S. Cl. CPC B66B 5/18; B66B 1/365

(57) ABSTRACT

A brake, in particular a safety brake, suitable for an elevator system having a guide rail and a caliper design. The brake includes two brake shoes and a first and second brake lever rotatably connected to each other via a swivel joint. A spring arrangement is configured to impinge on the first brake lever relative to the second brake lever in a first direction. An actuator arrangement is designed selectively to impinge on the first brake lever relative to the second brake lever in a second direction. The brake levers are configured to transfer the brake shoes between a first released operating state and a second active operating state as a function of the impingement by the spring arrangement and the actuator arrangement. The spring arrangement includes at least one plate spring assembly having in each case one or more plate springs.

A safety brake serves for braking the car of an elevator system in an emergency if, for example, too great a speed has been detected, in an extreme case in the event of a rupture of the supporting means. In modern elevators, which have a plurality of cars in one shaft, the safety brake also serves for rapid braking if two cars do not comprise sufficient safety distance from one another. In this case, a maximum braking force is generally provided by the safety brake; generally in safety brakes the braking force is not metered.

Generally, in safety brakes mechanical wedges or eccentrics are placed onto the rail, said wedges or eccentrics automatically retracting as far as a defined end point in the case of further travel of the car. As a result, a resilient element such as for example a plate spring assembly or the housing itself is widened to a sufficient extent that the desired normal force is produced in order to generate the required braking force between the friction linings and the rail. The spring characteristic curve may be designed to be very hard since it is only necessary to compensate for production tolerances and the wear of the brake linings. As a result, the spring elements may be designed to be relatively small and cost-effective and the working travel very small. However, these safety brakes have the drawback that from the activation of the brake to the full action thereof the wedges or eccentrics always have to cover a retraction distance. Optionally, the car may accelerate further during the retraction process. Both of these situations may result in the car coming to a standstill late. If the brake is retracted to begin with, only by moving the car in the opposing direction is it able to be deactivated again which makes a potential emergency release difficult.

Alternatively, brakes without wedges or eccentrics are known. In this case, the required normal force is directly applied to the brake linings. The spring elements are also generally small and cost-effective here, and the brake linings are held open by means of a linear movement. This design typically permits only small air gaps when the brake is open. However, the relative movements between the car and the guide rail are significantly greater. In this case, therefore, the brake would have to be floatingly mounted and the constant grinding of the brake linings tolerated. However, noise development, abrasion and wear have to be taken into account here.

EP 2 338 821 A1 discloses a safety brake having a caliper design. This safety brake comprises two brake levers which are rotatable relative to one another. In each case, brake linings are provided at a first end of the brake levers, the guide rail being arranged between said brake linings. Springs and/or actuators, which selectively impinge on the brake levers to force them apart or toward one another, are provided at a second end of the brake levers. In the last case, the brake is activated. This type of safety brake comprises advantages due to its design, in particular no components are used which are displaced during actuation transversely to the braking force. Instead the brake shoes are rotated about a rotational axis which runs parallel to the braking force direction, which permits an effective absorption of the braking forces. A drawback, however, is the tendency of the coil spring to buckle which is increased by the relative rotation of the brake levers. Costly measures for reducing this are either a lateral guidance of the coil spring or an articulated attachment of the coil spring to the brake levers.

It is the object of the present invention to provide an improved safety brake having a caliper design. The object underlying the invention is achieved by a brake, a brake arrangement, an elevator system and a method according to the main claims; preferred embodiments are disclosed in the subclaims and the description.

The brake according to the invention is, in particular, a safety brake and is suitable for an elevator system having a guide rail, the brake having a caliper design. The brake comprises: two brake shoes, a first brake lever and a second brake lever which are rotatably connected to each other via a swivel joint, a spring arrangement which is designed to impinge on the first brake lever relative to the second brake lever in a first direction, an actuator arrangement which is designed selectively to impinge on the first brake lever relative to the second brake lever in a second direction. The brake levers are designed to transfer the brake shoes between a first released operating state and a second active operating state, as a function of the impingement by the spring arrangement and the actuator arrangement. The spring arrangement comprises at least one plate spring assembly having in each case one or more plate springs.

In this case, the fact that the plate springs comprise a greater strength relative to lateral buckling is utilized. Due to their design, plate springs comprise a harder spring characteristic curve with comparable spring forces relative to coil springs. As a result, a shorter travel is required in order to provide the forces. This is associated with the advantage that it is sufficient to pivot the brake levers by a smaller angle. As a result, costly measures for reducing the tendency to buckling are superfluous.

In particular, springs according to the standard DIN 2093 are understood as plate springs. In particular, viewed in the active direction of the plate spring, a plate spring comprises a length which is less than a diameter of the plate spring.

Preferably, the first brake lever comprises a first spring bearing surface and the second brake lever comprises a second spring bearing surface which serves for bearing one of the at least one plate spring assemblies. The spring bearing surface may be formed by a separate element; thus said spring bearing surface does not have to be configured integrally with the remaining regions of the brake lever. However, a rigid attachment to the brake lever is preferred.

Preferably, the brake is configured such that the two spring bearing surfaces in a first operating state comprise a first pivoting relative to one another and in a second operating state comprise a second pivoting relative to one another, wherein the first pivoting and the second pivoting comprise different signs. This means that a parallel position of the two spring bearing surfaces is present, in particular when the brake is transferred from the released operating state into the active operating state. The pivoting (denoted more accurately by an angle specification) refers to a pivoting, in the viewing direction, parallel to the rotational axis of the two brake levers relative to one another; the first pivoting comprises, for example, a positive value and the second pivoting thus comprises a negative value.

As a result, the pivoting is understood as the angle which the two planes of the spring bearing surfaces adopt relative to one another. In accurate mathematical terms, the pivoting is defined by a cutting angle of two straight lines, wherein each of these straight lines is oriented perpendicular to one respective spring bearing surface. If the two spring bearing surfaces are oriented parallel to one another the pivoting is 0°. In this case, the respective smaller value is taken into account, for example −5° instead of −175°.

Preferably, the greater amount of the two pivotings represents a maximum pivoting and the amount calculated from the difference between the two pivotings represents a pivoting range, wherein the ratio of the pivoting range and maximum pivoting is greater than 1. The spring bearing surface, as a result, is pivoted by a pivoting range which is greater than the maximum pivoting. Accordingly, it is advantageous if the pivoting-out is as small as possible, whilst at the same time the pivoting range is as large as possible. Advantageously, the ratio of the pivoting range and the maximum pivoting is greater than 1.5, in particular is 2, which represents the optimal value. With a value of 2, half of the full pivoting range is respectively located on one side and on the other side of the parallel position.

Preferably, the amount of the first pivoting is a maximum of 6° and/or the amount of the second pivoting is a maximum of 6°.

Preferably, the spring arrangement comprises a guide element with a cylindrical guide portion, wherein the guide portion is received in a central opening of the plate spring assembly. The guide element holds the plate spring assembly with a plurality of plate springs radially adjacent to one another. A perfect cylindrical guide surface is not important in this case and even guide surfaces which are discontinuous but which as a whole comprise a cylindrical casing are sufficient.

Preferably, the guide element comprises a stop portion, wherein the plate spring assembly is clamped between the stop portion and the assigned brake lever. In particular, the spring arrangement comprises two plate spring assemblies, wherein each plate spring assembly comprises a guide element and a stop portion, wherein the two guide elements are fixedly connected to each other. A spacing between the stop portions of the two guide elements is, in particular, relatively adjustable, in particular by using a separate spacer element arranged between the two guide elements or by means of a threaded element. A separate spacer element may be arranged between the two guide elements. As a result, the mounting may be carried out in a simple manner. Preferably, the two guide elements in each case are fixedly connected to each other on the stop portions thereof. By a specific choice of spacer element, the pretensioning of the spring arrangement may be adjusted.

The invention further relates to a brake arrangement comprising an aforementioned brake and a guide rail which interacts with the brake.

The invention further relates to an elevator system comprising a car which is movable inside a shaft in a direction of travel.

The car is guided by at least one guide rail. The elevator system comprises at least one brake of the aforementioned type.

The invention further relates to a method for mounting such a brake, the method comprises the following method steps:
inserting a first guide element into a central opening of the first plate spring assembly and placing the first plate spring assembly onto the first brake lever;
inserting a second guide element into a central opening of the second plate spring assembly and placing the second plate spring assembly onto the second brake lever; fastening the two guide elements to each other. The two guide elements in each case may be fastened to each other on the stop portion thereof.

The invention is described in more detail hereinafter with reference to the figures; in which

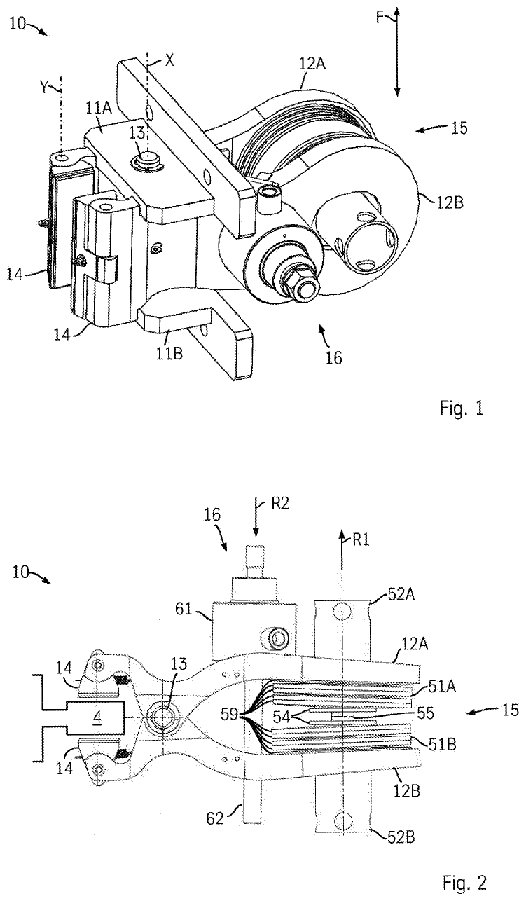

FIG. 1 shows a brake according to the invention in a perspective view;

FIG. 2 shows the brake according to FIG. 1 in a plan view;

FIG. 3 shows a brake lever of the brake according to FIG. 1 in a perspective view;

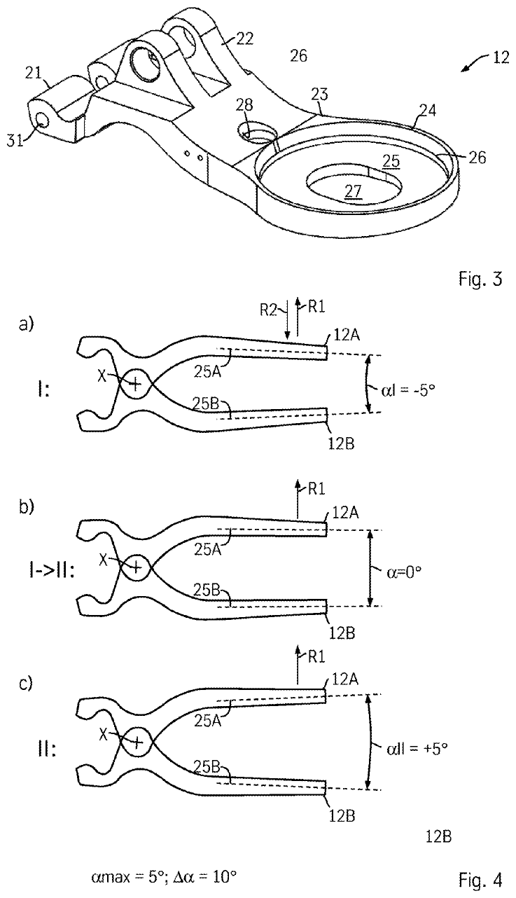

FIG. 4 shows two brake levers of the brake according to FIG. 1 in a plan view

a) during the released state of the brake,

b) during the transition from the released into the active state of the brake,

c) during the active state of the brake;

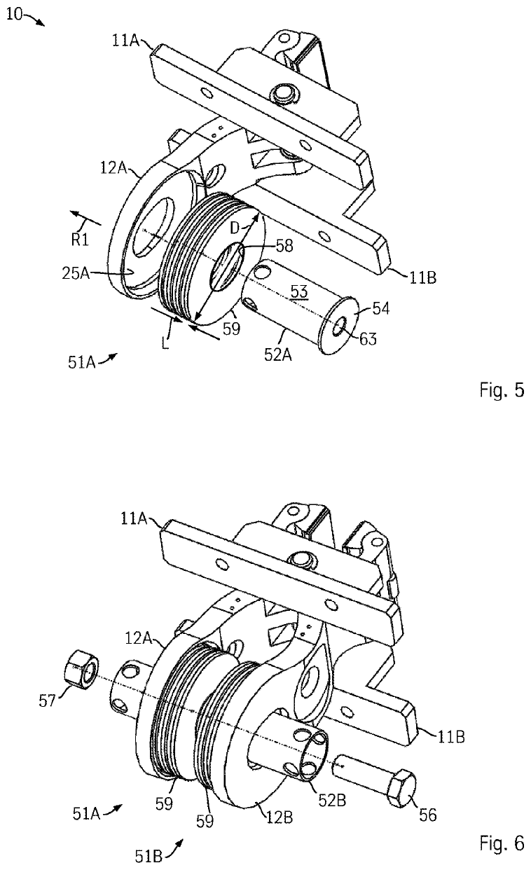

FIG. 5 shows the brake according to FIG. 1 in a perspective view in a first mounting phase;

FIG. 6 shows the brake according to FIG. 1 in a perspective view in a second mounting phase;

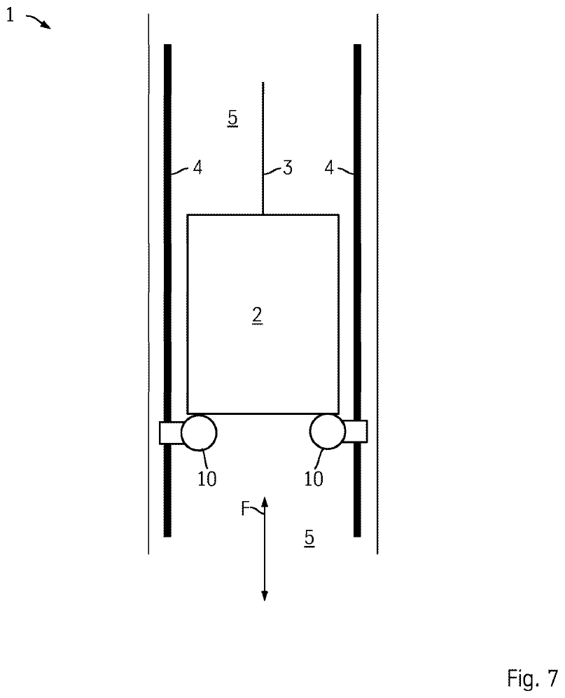

FIG. 7 shows an elevator system according to the invention comprising a brake according to FIG. 1.

FIG. 7 shows an elevator system 1 according to the invention. The elevator system 1 comprises a shaft 5, in which a car 2 is movably received. The car 2 is guided by guide rails, wherein in principle one guide rail 4 may be sufficient. The car is driven via a cable drive comprising a cable 3 and a drive motor, not shown. The drive may also be implemented in a different manner, for example using a linear drive. Two brakes 10 according to the invention are arranged on the car 2, said brakes being able to be activated, in particular, if the car 2 has to be braked in an unscheduled and rapid manner, for example in the case of a rupture of the supporting means. In this regard, the brake is in particular a safety brake. The braking force of such safety brakes during operation is, in particular, not able to be metered.

The brake 10 is described in more detail with reference to FIGS. 1 to 6. The brake 10 has a caliper design. To this end, the brake 10 comprises a first brake lever 12A and a second brake lever 12B. The two brake levers 12 are in the present case configured exactly identically but they do not have to be configured exactly identically. Only one brake lever 12 is described hereinafter, representing the two brake levers 12A, 12B, and the construction of the brake lever 12 may be identified most clearly in FIG. 3.

The brake lever 12 comprises an active portion 21, a joint portion 22 and an actuating portion 23. A possibility for fastening a brake shoe 14 (see FIGS. 1 and 2) is provided on the active portion 21. In the present case, the possibility for fastening a brake shoe 12 is a brake shoe bore 31, the brake shoe 14 being pivotably fastened thereto by means of a bolt. The axis Y of the brake shoe bore 31, which as a result represents the rotational axis of the brake shoes 14, is oriented parallel to the direction of travel F (see FIG. 2). On the joint portion 22 the brake lever 12 comprises a joint bore 32, whereby the two brake levers 12 are connected together by means of a bolt and thus form a swivel joint 13 (see FIG. 2). The rotational axis X of the swivel joint is oriented parallel to the direction of travel F (see FIG. 2).

On the actuating portion 23 the brake lever 12 comprises a spring plate 24 with a spring bearing surface 25, a spring arrangement 15 (see FIGS. 1 and 2) being able to be placed thereon. In the present case, the spring arrangement 15 comprises two plate spring assemblies 51A, 51B. A peripheral guide edge 26 of the spring plate 24 defines the spring bearing surface 25. The guide edge 26 prevents the springs of the abutting spring arrangement 15 from being forced out to the side. Moreover, the brake lever 12 on the actuating portion 23 comprises an actuator opening 28, the actuating rod 62, defined further below, being guided therethrough. The joint portion 22 is arranged between the actuating portion 23 and the active portion 21. Via the swivel joint 13 the brake levers 12A, 12B are connected to two mounting plates 11. The brake 10 is fastened to the car 2 on the mounting plates 11. The brake levers 12 in this case are designed such that the active portions 21 move toward one another when the actuating portions 23 move away from one another. In this regard, the kinematics of the brake 10 in the present case differ from the kinematics of conventional pliers, for example a pipe wrench.

The principal function of the brake 10 may be described most clearly with reference to FIGS. 1 and 2. The guide rail 4 is arranged between the brake shoes 14 which in each case are fastened to one of the brake levers 12A, 12B (only illustrated in FIG. 2). In this case FIG. 2 shows the brake 1 in a first released operating state. The brake levers 12 hold the brake shoes 14 spaced apart from the guide rail 4 in this first operating state. To this end, the brake comprises an actuator arrangement 16 comprising an actuator 61 and an actuating rod 62. The actuator arrangement 16 in this case is designed to impinge upon the two actuating portions 23 to force them toward one another in the second direction R2 so that the respective active portions 21 of the two brake levers 12A, 12B are impinged upon so as to be forced apart from one another. In the present example, the actuator 61 is configured as a hydraulic traction actuator, wherein other actuators are also possible, however.

A spring force of the plate spring assemblies 51A, 51B is countered by a tensile force of the actuator. The plate spring assemblies 51A, 51B impinge upon the spring bearing surface 25 and thus the actuating portions 23 in a first direction R1 away from one another. When the brake is released, the action (in this case the lever action) of the actuator arrangement 16 in the second direction R2 is greater than the action of the spring arrangement 15 in the first direction R1. When the brake is actuated, the force of the actuator 61 is no longer required; the actuator arrangement 16 is thus no longer able to impinge upon the two actuating portions 23 sufficiently to force them toward one another in the first direction R1. Due to the spring force of the plate spring assemblies 51, the brake shoes 14 are impinged upon so as to be forced toward one another on the active portions 21 and clamp the guide rail 4 between one another.

In principle, the first direction R1 is understood to mean within the scope of this exemplary embodiment that the spring bearing surfaces 25 of the two brake levers 12A, 12B move away from one another. In principle, the second direction R2 is understood to mean within the scope of this exemplary embodiment that the spring bearing surfaces 25 of the two brake levers 12A, 12B move toward one another.

Particular importance is given to the spring bearing surfaces and reference is made hereinafter to FIG. 4, in which the brake levers 12A, 12B are shown separately. FIG. 4a shows the brake levers 12A, 12B in the first released operating state I, and FIG. 4c shows the brake levers 12A, 12B in the second active operating state II. In FIG. 4b the brake levers are shown in an intermediate position which the brake levers 12A, 12B briefly adopt in the transition from the first operating state to the second operating state.

Due to the rotation of the two brake levers the pivoting of the two spring bearing surfaces 25A, 25B alters relative to one another. In order to prevent a risk of buckling, it is always advantageous to keep the pivoting as close as possible to a parallel orientation (angle α=0°). The parallel orientation is shown in FIG. 4b. In the first operating state, the two spring bearing surfaces 25A, 25B adopt relative to one another a first pivoting αI which in this case is approximately −5°. In the second operating state, the two spring bearing surfaces 25A, 25B adopt relative to one another a second pivoting αII which in this case is approximately +5°. The amount of the first and the second pivoting and thus the maximum pivoting a max is 5°.

In the transition between the two operating states the brake levers 12 rotate relative to one another by 10° (pivoting range=10°). Since the respective pivoting from the parallel position in each direction of +/−5° represents half of the amount of the pivoting range of 10°, the ratio of the pivoting range to the maximum pivoting is maximized (here this ratio adopts the optimal value of 2). As a result, a pivoting range which is as large as possible is implemented with a risk of buckling which is as small as possible.

For comparison: in the brake disclosed in EP 2 338 821 A1 the entire pivoting range is located on one side of the parallel position. Thus by way of example a pivoting in the first operating state could be +2°, whilst a pivoting in the second operating state could be +12°; even if in this case a pivoting range of 10° were present, the maximum pivoting value would be 12°; as a result the aforementioned ratio of the pivoting range to the maximum pivoting is 10/12, i.e. approximately 0.83 and thus significantly more disadvantageous. The risk of buckling is greater, even when using similar springs.

A ratio of 1.0 is present when the first or the second pivoting is 0°. If the parallel position is only reached during the transition between the two operating states, the ratio is greater than 1. A ratio of 2 represents the maximum and thus the optimal value.

If in one embodiment a planar spring bearing surface were not present, the aforementioned angle specifications would not be able to be accurately derived from the geometry of the brake levers. In this case, in order to determine the angle, for example, a planar surface might be notionally constructed; for the purposes of the present invention it is essential here that the constructed planar surface is oriented so as to be mirror-inverted relative to the angular position of the plate spring, since ultimately it depends on the angular position thereof.

The mounting of the brake 10 is described with reference to FIGS. 5 and 6. In a first step, the first plate spring assembly 51A is mounted. To this end, a first guide element 52A is inserted with an outer cylindrical guide portion 53 into a central opening 58 of the plate springs 59 until an axial stop portion 54 of the guide element 52A lies on a first side against the plate springs 59. The axial stop 54 in this case comprises a greater diameter than the opening 58 of the plate springs 59. On the other side the plate springs 59 are placed against the spring bearing surface 25A of the first brake lever 12A. The same steps are carried out for the second plate spring assembly 51B corresponding to the second brake lever 12B and a second outer cylindrical guide element 52B.

In this case, the axial stop portions 54 of the two guide elements 52 are oriented toward one another. Subsequently, the two guide elements 52A, 52B are fastened together. This may be carried out by a screw connection (nut 57, screw 56) of the stops 54 respectively facing one another. The screw 56 in this case is passed through an opening 63 in the guide element. Thus a general guide element is produced from the individual guide elements 52A, 52B. In this case, a spacer washer may be used individually as a spacer element between the two guide elements 52A, 52B, whereby the pretensioning of the spring arrangement is adjusted. Alternatively, for adjusting the spacing of the stops 54 the opening 63 in the guide element may be configured as a threaded bore which has an internal thread which is complementary to the screw 56. Therefore, the pretensioning of the spring arrangement varies according to the rotational position of the guide element 53 relative to the screw. The rotational position may be fixed by a lock nut.

The two brake levers 12A, 12B are screwed to the mounting plates 11, wherein the term “plate” is to be understood broadly and does not require a planar shape. A central sleeve opening 27 on the spring plate 25 permits a substantially unhindered movement of the guide element 52 relative to the brake lever 12 in the axial direction (parallel to the first or second direction R1, R2). The central sleeve opening 27, however, may effect a radial guidance (transversely to the first or second direction R1, R2). The terms “radial” and “axial” refer here to the approximate axis of the plate springs.

The rotational axis X between the brake levers 12 relative to one another is oriented parallel to the direction of travel F, in which the braking force also acts. In this regard, the braking force has no effect on the rotational position of the brake levers relative to one another.

The rotational axis Y between a brake shoe 14 and the assigned brake lever 12 is oriented parallel to the direction of travel F in which the braking force also acts. In this regard, the braking force has no effect on the rotational position of the brake shoes relative to the respective brake lever.

In particular, a plate spring viewed in the active direction of the plate spring comprises a length L which is less than a diameter D of the plate spring.

### List of reference numerals

1 Elevator system
2 Car
3 Cable
4 Guide rail
5 Shaft
10 Safety brake
11 Mounting plate
12 Brake lever
13 Swivel joint
14 Brake shoe
15 Spring arrangement
16 Actuator arrangement
21 Active portion
22 Joint portion
23 Actuating portion
24 Spring plate
25 Spring bearing surface
26 Peripheral spring guide edge
27 Sleeve opening
28 Actuator opening
31 Brake shoe bore
32 Joint bore
51 Plate spring assembly
52 Guide sleeve
54 Guide portion
54 Stop portion
55 Spacer washer
56 Screw
57 Nut
58 Central opening of plate springs
59 Plate spring
61 Actuator
62 Actuating rod
63 Opening in guide element
X Rotational axis of brake levers
Y Rotational axis of brake shoes relative to brake levers
F Direction of travel
L Length of plate spring
D Diameter of plate spring

1.-15. (canceled)

16. A brake for an elevator system having at least one guide rail, the brake having a caliper design comprising:
two brake shoes,
a first brake lever and a second brake lever,
a swivel joint that rotatably connects the first brake lever to the second brake lever,
a spring arrangement configured to impinge on the first brake lever relative to the second brake lever in a first direction,
an actuator arrangement configured selectively to impinge on the first brake lever relative to the second brake lever in a second direction,
wherein the brake levers are configured to transfer the brake shoes between a first released operating state and a second active operating state as a function of the impingement by the spring arrangement and the actuator arrangement, and
wherein the spring arrangement comprises at least one plate spring assembly having in each case one or more plate springs.

17. The brake of claim 16 wherein the first brake lever comprises a first spring bearing surface and the second brake lever comprises a second spring bearing surface, which serves for bearing one of the at least one plate spring assembly.

18. The brake of claim 17 wherein the brake is configured such that the two spring bearing surfaces in the first operating state comprise a first pivoting to one another and in the second operating state comprise a second pivoting to one another, wherein the first pivoting and the second pivoting comprise different signs.

19. The brake of claim 18 wherein the greater amount of the two pivotings represents a maximum pivoting and in that the amount calculated from the difference between the two pivotings represents a pivoting range, wherein the ratio of the pivoting range and the maximum pivoting is greater than 1.

20. The brake of claim 19 wherein the ratio of the maximum pivoting and pivoting range is greater than 1.5

21. The brake of claim 19 wherein the ratio of the maximum pivoting and pivoting range is 2.

22. The brake of claim 19 wherein the amount of the first pivoting is a maximum of 6° and/or the amount of the second pivoting is a maximum of 6°.

23. The brake of claim 16 wherein the spring arrangement comprises a guide element with a cylindrical guide portion and the guide portion is received in a central opening of the plate spring assembly.

24. The brake of claim 23 wherein the guide element comprises a stop portion, wherein the plate spring assembly is clamped between the stop portion and the corresponding one of the first and second brake lever.

25. The brake of claim 24 wherein the spring arrangement comprises two plate spring assemblies, wherein each plate spring assembly comprises a guide element with a stop portion, wherein the two guide elements are connected to each other.

26. The brake of claim 24 wherein the two guide elements are connected fixedly to each other.

27. The brake of claim 25 wherein a spacing between the stop portions of the two guide elements is relatively adjustable by using a separate spacer element arranged between the two guide elements or by means of a threaded element.

28. The brake of claim 25 wherein the two guide elements in each case are fixedly connected to each other on the stop portions thereof.

29. A brake arrangement comprising the brake of claim 16 and a guide rail.

30. A method for mounting a brake comprising two brake shoes, a first brake lever and a second brake lever, a swivel joint that rotatably connects the first brake lever to the second brake lever, a spring arrangement configured to impinge on the first brake lever relative to the second brake lever in a first direction, an actuator arrangement configured selectively to impinge on the first brake lever relative to the second brake lever in a second direction, wherein the brake levers are configured to transfer the brake shoes between a first released operating state and a second active operating state as a function of the impingement by the spring arrangement and the actuator arrangement, and wherein the spring arrangement comprises at least one plate spring assembly having in each case one or more plate springs wherein the spring arrangement comprises two plate spring assemblies, wherein each plate spring assembly comprises a guide element with a stop portion, wherein the two guide elements are connected to each other, the method comprising:
inserting a first guide element into a central opening of the first plate spring assembly and placing the first plate spring assembly onto the first brake lever;
inserting a second guide element into a central opening of the second plate spring assembly and placing the second plate spring assembly onto the second brake lever; and
fastening the two guide elements to each other.

31. The method of claim 30, wherein the two guide elements in each case are fastened to each other on the stop portion thereof.
